(19) United States
(12) Patent Application Publication
(10) Pub. No.: US 2011/0134234 A1
(43) Pub. Date: Jun. 9, 2011

(54) ELECTRONIC MICROSCOPE

(75) Inventor: Chang Hyun Kim, Seoul (KR)

(73) Assignee: Omega vision CO., LTD., Seoul (KR)

(21) Appl. No.: 12/634,404

(22) Filed: Dec. 9, 2009

(51) Int. Cl. H04N 7/18

(52) U.S. Cl. 348/80; 348/E07.085

(57) ABSTRACT

An electronic microscope includes a handle having an outer body enclosing a main body and an image sensor, a lens controller fixed to the front end of the outer body of the handle, and a light guide coupled to the front end of the lens controller. The lens controller includes an inner case having a guide slot in the circumference and a flange on one end to which the handle is coupled, an outer case rotatably coupled with the inner case from outside and having a spiral passage in the circumference communicating with the guide slot, and a lens unit inserted into the inner case. The lens unit moves back and forth in response to rotation of the outer case. The light guide includes a LED board, LEDs radially mounted on the LED board, and an observation filter detachably provided on the front end of the lens controller.

### BACKGROUND OF THE INVENTION

1. Field of the Invention

The present invention relates to an electronic microscope. More particularly, the present invention relates to an electronic microscope that can pick up an image of a specific body region, such as the skin, the scalp, or the interior of the mouth, ears, or nose, and display the image by magnifying it in order to enable early diagnosis of a disease and its proper treatment, and that can be easily connected to a Personal Computer (PC) so that the magnified image of the skin or the interior of the ears can be observed at home, or so that specific body regions, such as the back or the nape of the neck, which a user cannot observe with the naked eye by him/herself, can be observed via a computer monitor.

2. Description of Related Art

In general, a digital imaging system includes an electronic microscope and a display device. The electronic microscope picks up an image of an object to be examined by magnifying it and converting the magnified image into electrical image signals. The display device serves to display the electrical image signals on a monitor after receiving the signals via a cable.

A conventional electronic microscope used in such a digital imaging system includes a Charge-Coupled Device (CCD) or Complementary Metal Oxide Semiconductor (CMOS) sensor, a handle, a lens controller, a Light Emitting Diode (LED), and a light guide. A Printed Circuit Board (PCB), on which an image memory and a switch are mounted, is installed inside the handle. The lens controller is attached to the front end of the handle to move a group of lenses back and forth. The LED is provided on the front end of the lens controller to emit light. The light guide has a light guide cap that protects the LED.

In such an electronic microscope, light emitted from the LED is reflected by the object to be examined, is magnified by, for example, a group of zoom lenses or a group of image magnification lenses, and is converted into electrical image signals by a CMOS or CCD sensor. The converted image signals are input into a microscope controller via a cable, and the image signals, after being processed by the microscope controller, are displayed on a display device.

The conventional electronic microscope is used in digital imaging systems for a variety of applications. Such applications include, for example, industrial applications such as the surface treatment of products, precious metals, the fabrication of molds, molded products, main components used in electrics and electronics, fabric patterns used in the textile industry, the examination of the structure of a materials; education and scientific research applications such as the observation of insects, microorganisms, hairy caterpillars, and plant textures and the structure of stones; applications in home health care utensils for observing the mouth, skin, ear, scalp, nose, skin pores, teeth, and specific body regions; the diagnosis of dental cavities and mouth care (i.e., laryngograph); and various other applications.

However, the conventional electronic microscope used in the digital imaging system fails to correctly pick up an image of an object to be examined since the entire object is not uniformly illuminated by the light that is emitted from the LED, because it is propagated directly on the object.

In addition, the light reflected from the object to be examined is sent to a CMOS sensor through a group of lenses and is then converted into image signals by the CMOS sensor. However, the light from the lens group is reflected from the surface of the CMOS sensor and is then reflected again from the surface of the lenses of the lens group before it enters the CMOS sensor, which converts the reflected light into image signals. As a result, the superimposed images disadvantageously degrade image quality to the extent that minute structures are not recognizable.

In addition, the conventional electronic microscope for the digital imaging system is not easy to use at home because, in order to adjust the magnification of the image of the object to be examined, a group of zoom lenses and a group of magnification lenses must be separately provided, or, alternatively, a light guide cap having a suitable magnification must be coupled to the electronic microscope.

In addition, the electronic microscope for the digital imaging system as described above is a very expensive and specialized product in which an image processing device and a monitor are provided together with the electronic microscope. Thus, it is not practical for use in homes, small factories, school laboratories, or the like.

Furthermore, the conventional electronic microscope for the digital imaging system is not suitable for observing specific regions of the body, such as ears, nose, and mouth.

In particular, in order to diagnose a disease in the body by observing an acupuncture spot in the ear, it is important to display the corresponding spot in the ear on a monitor by magnifying it. The conventional electronic microscope does not properly magnify specific one of acupuncture spots, which are densely distributed in the ear, but magnifies surrounding acupuncture spots or shows part of a specific acupuncture spot. Accordingly, it is very difficult to observe only a single acupuncture spot.

In addition, since the conventional electronic microscope is not designed for the observation of acupuncture spots in the ear, a focal length and a magnification are not optimally set. In order to properly observe a specific acupuncture spot, it is required to move the electronic microscope or continuously change the magnification according to the distance to the skin. Accordingly, a user cannot properly observe the acupuncture spot if he/she is not a skilled expert.

Furthermore, in order to diagnose a disease by observing an acupuncture spot in the ear, it is required to precisely observe features of the acupuncture spot, for example, changes in color (e.g., congestion and brown or white spots), wrinkles, depressions, or deformation. However, the conventional microscope cannot uniformly illuminate the object to be examined because the light is directly propagated from the LED. Accordingly, the shape or color of the object to be examined is not properly observed.

Although changes in the color of the acupuncture spot are especially important, the color is not properly observed using the conventional electronic microscope since the LED itself has a characteristic color, or the emitted light is not uniformly diffused.

In addition, it is required to display an image picked up by the electronic microscope on the monitor so that the user can diagnose disease while watching the image. However, in the conventional digital imaging system, since the image picked up by the electronic microscope is displayed on a rectangular screen of a display, it is difficult to identify the acupuncture spot.

Furthermore, in order to accurately observe the acupuncture spot, it is necessary to use as much of the screen of the display as possible. However, in the conventional electronic microscope, it is difficult to accurately observe the acupuncture spot since the image is frequently displayed in a small portion of the screen according to the position and magnification of a camera

The information disclosed in this Background of the Invention section is only for enhancement of understanding of the background of the invention and should not be taken as an acknowledgment or any form of suggestion that this information forms the prior art that is already known to a person skilled in the art.

### BRIEF SUMMARY OF THE INVENTION

Various aspects of the present invention provide an electronic microscope that can accurately pick up an object to be examined by radiating light having uniform brightness to the object and produce a clear and clean image of the object, which is converted into electrical image signals, by scattering light reflected from a CCD or CMOS sensor.

There is also provided an electronic microscope that can be conveniently used at an inexpensive price in homes or Oriental medicine clinics to observe a specific body region by magnifying it, in school laboratories to observe a test sample, or in small factories to observe a precise component by magnifying it since the electronic microscope is easy to use due to its simple structure and is easy to connect to a PC or a TV monitor via a Universal Serial Bus (USB) port or a TV video port.

Furthermore, there is provided an electronic microscope, which has a filter capable of observing acupuncture spots in the ears, in order to easily observe the acupuncture spots in the ears.

In an aspect of the present invention, the electronic microscope may include a handle having an outer body enclosing a main body and an image sensor such as a CMOS or CCD sensor, in which an image memory, a tact switch, and a USB port are mounted on the main board; a lens controller fixed to the front end of the outer body of the handle, in which the lens controller includes an inner case having a guide slot in the circumference and a flange on one end to which the handle is coupled, an outer case rotatably coupled with the inner case from outside, in which the outer case has a spiral passage, such as a spiral hole or a spiral groove, in the circumference communicating with the guide slot, a lens unit inserted into the inner case, in which the lens unit has a guide rod inserted into the guide slot and into the spiral passage such that the lens unit moves back and forth in response to rotation of the outer case; and a light guide coupled to the front end of the lens controller, in which the light guide includes a LED board, LEDs radially mounted on the LED board, and an observation filter detachably provided on the front end of the lens controller, in which the observation filter has a conical shape with the diameter decreasing toward the front end thereof, and observes body regions including the skin, scalp, nose, mouth, ears, and acupuncture spots in the ears.

The light guide may also include a diffusion member or diffusion plate coupled with the LED board by a coupling rod, in which the diffusion member provides light having uniform brightness to an object to be examined by uniformly diffusing light emitted from the LEDs.

The lens controller may also include a main case covering the outer circumference of the outer case and a focus adjustor provided on one end of the outer case, in which the focus adjustor rotates the outer case from outside, so that the lens unit can be precisely adjusted.

The lens unit may include a lens body fixing one or more lenses, a plurality of spacers provided in the inner circumference of the lens body to maintain the lenses apart from each other, the guide rods protruding both sides of the outer circumference of the lens body, and a first reflection-preventing section provided on the inner circumference of the rear end of the lens body, in which the first reflection-preventing section has a diffusely reflective portion that scatters light reflected from the image sensor in order to provide a clear and clean image.

The flange of the inner case may have a second reflection-preventing section in which a diffusely reflective portion is formed, in which the diffusely reflective portion scatters light reflected from the image sensor that converts light reflected from an object to be examined into electrical signals.

The inner case may have a third reflection-preventing section therein, which allows the lens unit to move and has a diffusely reflective portion scattering light reflected from the image sensor.

The diffusely reflective portion may have a roughened portion selected from the group consisting of a scratched portion, a diffusely reflective coating, tapped portions, and threaded portions, in which the surface of the roughened portion is roughened to scatter the light reflected from the image sensor.

The diffusely reflective portion may have threaded portions, which are oriented at an angle of 60 degrees and cut to a depth of 0.5 mm.

The front end of the observation filter may have a diameter from 2 to 7 mm and a height from 15 to 30 mm.

The electronic microscope may further include a stand for holding the electronic microscope, in which the stand has a holder extending downward such that the electronic microscope is inserted into the holder with the light guide facing down.

The outer body of the handle may have a plurality of ribs to which the flange on one end of the inner case and an image sensor board are fixed; a plurality of support ribs on which main board is provided; a plurality of fixing ribs holding a universe serial bus cable; and a fitting portion extending along an outer circumferential portion thereof so as to be rotatably coupled with the outer case.

The outer case may include a funnel portion in the form of an orifice, with the diameter gradually increasing, such that the funnel portion is rotatably coupled with the fitting portion, and an annular fitting groove, which is formed in the inner circumference of the funnel portion and is rotatably coupled with the fitting portion.

The light guide may include a light guide cap fixed to the front end of the inner case and bent at a right angle; a total reflection mirror fixed to the front end of the inner case and inclined at an angle of 45 degrees; the LED board provided in the front end of the light guide cap and having an annular shape, in which a plurality of the LEDs mounted on the LED board are chip-type; a protective cap detachably coupled with the front end of the light guide cap to prevent impurities from entering; and the observation filter provided on the front end of the protective camp and having a conical shape.

The flange provided on one end of the inner case may be coupled with the outer body of the handle and has a seating recess in which the image sensor is placed therein.

The electronic microscope may further include a closing member coupled with the front end of the inner case to close the guide slot of the inner case and coupled with the light guide, in which the closing member has a fitting recess in the inner circumference coupled with the inner case, an insert protrusion inserted into the front end of the guide slot in the circumference of the inner case, and a fixing recess to which the light guide is fixed.

The inner case may have a fitting protrusion in the front end thereof coupled with the fitting recess of the closing member, and in which the light guide has a fixing protrusion fixedly inserted into the fixing recess of the inner case.

The guide slot in the circumference of the inner case may have a plurality of inclined guide slot portions, which guide the lens unit in order to precisely control the lens group that moves back and forth along the guide slot.

The lens unit moves back and forth in response to the rotation of the outer case, which is provided outside and rotatably coupled with the inner case, in order to set a ratio of magnification and the focus according to a ratio of distance with respect to the CMOS sensor.

The electronic microscope may further include a microscope stand, which includes a fixing mount holding the electronic microscope spaced apart from a surface where the microscope stand is placed, a rotatable mount rotatably coupled with the fixing mount, and a holder coupled with the rotatable mount, in which the electronic microscope is held in the holder.

The outer body of the handle and the outer case of the lens controller may have a plurality of anti-slip protrusions formed on the outer circumference, in which the anti-slip protrusions prevent slipping when a user holds the handle.

According to exemplary embodiments of the present invention as set forth above, the diffusion member or diffusion plate radiates light having uniform brightness on the entire surface of the object by uniformly diffusing light emitted from the LEDs, and the first and second reflection-preventing sections scatter light reflected from the CCD or CMOS sensor after reflected from the object to be examined. This, as a result, makes it possible to produce a clear and clean image of the object, which is converted into electrical image signals, as well as to recognize a minute structure of the object to be examined so as to ensure precise observation, thereby improving reliability.

In addition, according to exemplary embodiments of the present invention, the electronic microscope can be conveniently used at an inexpensive price in homes, Oriental medicine clinics, school laboratories, or small factories since it is easy to use due to its simple structure and is easy to connect to a PC or a TV monitor via a USB port or a TV video port. Accordingly, the practicability and value of the electronic microscope can be improved.

Furthermore, according to exemplary embodiments of the present invention, since the electronic microscope is easily connectable to a PC via a USB port, it is possible to observe the skin or scalp by magnifying it without using expensive equipment at home as well as to easily observe body regions, such as the interior of the ears and nose, which are difficult to observe with the naked eye, and the acupuncture spots in the ears.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1A is an assembled perspective view showing an electronic microscope according to a first exemplary embodiment of the invention;

FIG. 1B is an exploded perspective view of FIG. 1A;

FIG. 2 is a longitudinal cross-sectional view showing the internal structure of the electronic microscope according to the first exemplary embodiment of the invention;

FIG. 3 is a perspective view showing an observation filter of a light guide of the electronic microscope according to the first exemplary embodiment of the invention;

FIG. 4 is a perspective view showing a diffusion member of the electronic microscope according to the first exemplary embodiment of the invention;

FIG. 5A is a longitudinal cross-sectional view showing a lens unit of the electronic microscope according to the first exemplary embodiment of the invention;

FIG. 5B is a perspective cross-sectional view showing a lens controller of the electronic microscope according to the first exemplary embodiment of the invention;

FIG. 6A is a diagram and formulas showing the magnification and the focal distance of the electronic microscope according to the first exemplary embodiment of the invention;

FIG. 6B is a conceptual view showing the structure of the lens unit and the magnification of the electronic microscope according to the first exemplary embodiment of the invention;

FIG. 7 is a perspective view showing a stand of the electronic microscope according to the first exemplary embodiment of the invention;

FIG. 8 is a perspective view showing an electronic microscope according to a second exemplary embodiment of the invention;

FIG. 9 is an exploded perspective view showing the electronic microscope according to the second exemplary embodiment of the invention;

FIG. 10 is a longitudinal cross-sectional view showing the electronic microscope according to the second exemplary embodiment of the invention;

FIG. 11 is diagrams showing the principle of image magnification of the electronic microscope according to the invention;

FIG. 12 is an exploded perspective view showing outer bodies of the electronic microscope according to the second exemplary embodiment of the invention;

FIGS. 13A to 13C are perspective views showing an inner case of the electronic microscope according to the second exemplary embodiment of the invention;

FIG. 14 is a partially cut-away perspective view showing an outer case of the electronic microscope according to the second exemplary embodiment of the invention;

FIG. 15 is a perspective view showing a light guide cap of the electronic microscope according to the second exemplary embodiment of the invention; and

FIG. 16 is a perspective view showing a stand, which holds the electronic microscope according to the second exemplary embodiment of the invention in an erected position.

### DETAILED DESCRIPTION OF THE INVENTION

Reference will now be made in detail to various embodiments of the present invention(s), examples of which are illustrated in the accompanying drawings and described below. Throughout this document, reference should be made to the drawings, in which the same reference numerals and signs are used throughout the different drawings to designate the same or similar components. In the following description of the present invention, detailed descriptions of known functions and components incorporated herein will be omitted when they may make the subject matter of the present invention unclear.

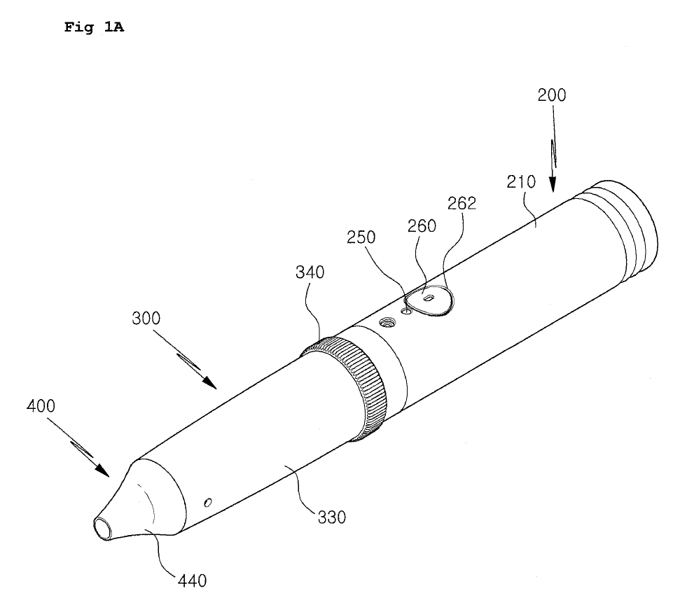

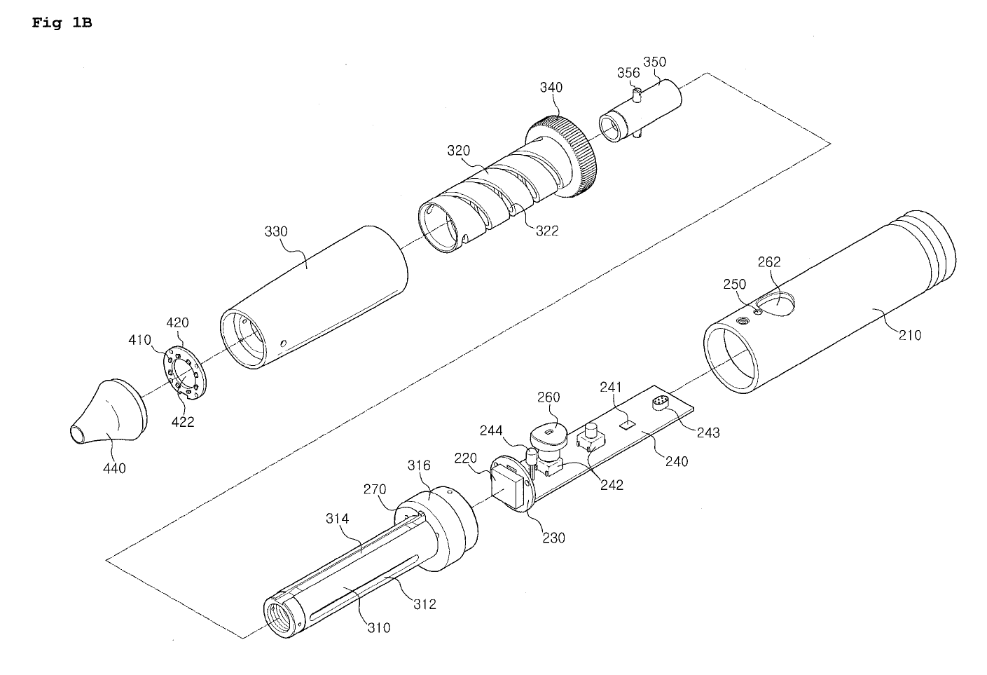

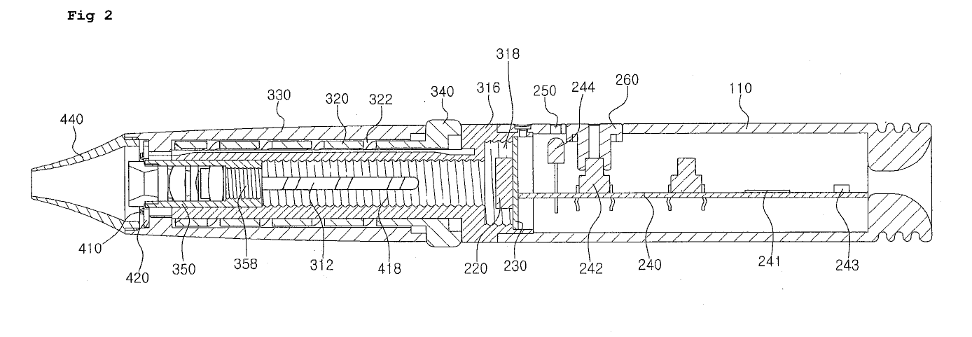

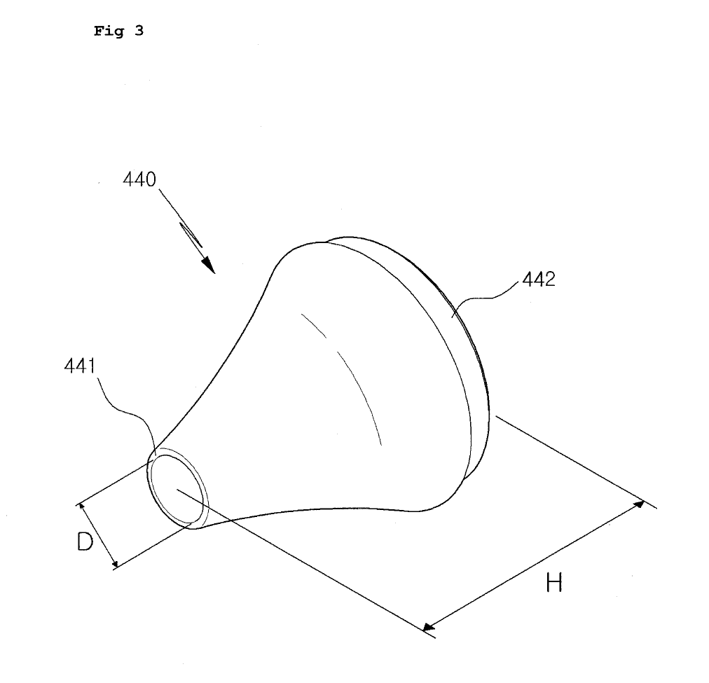

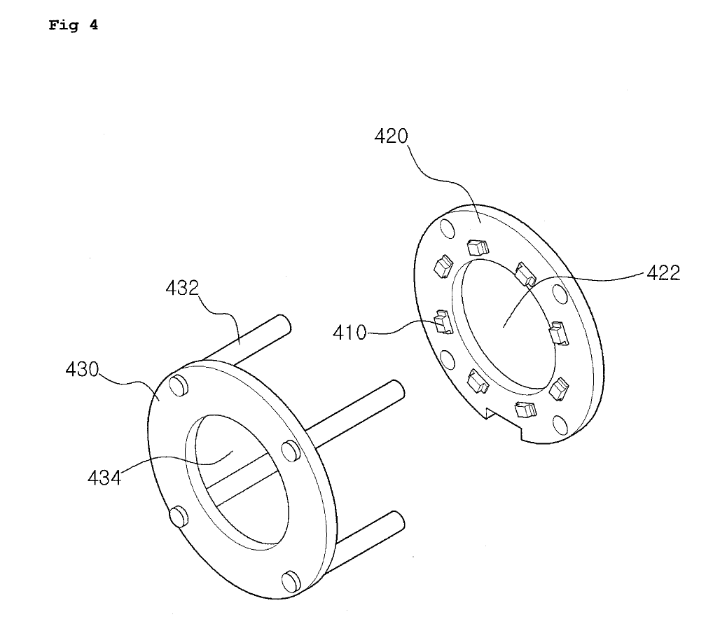

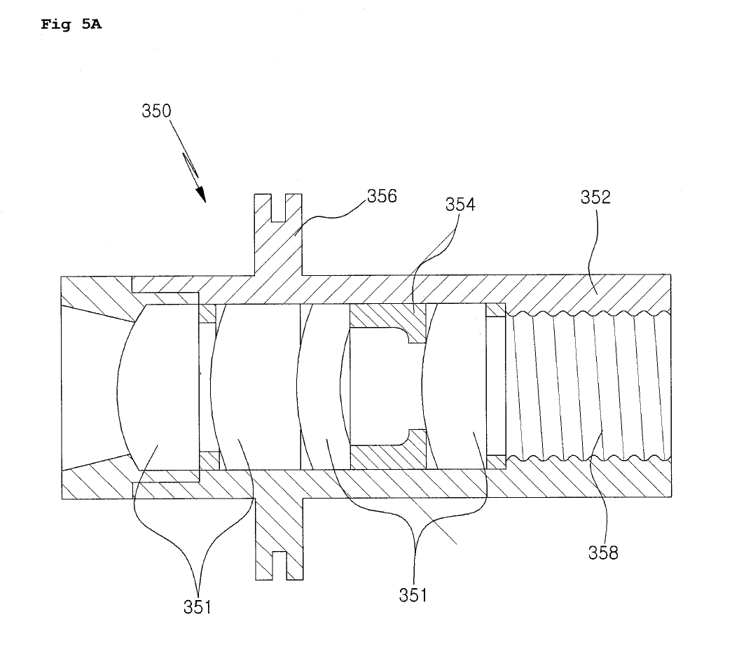

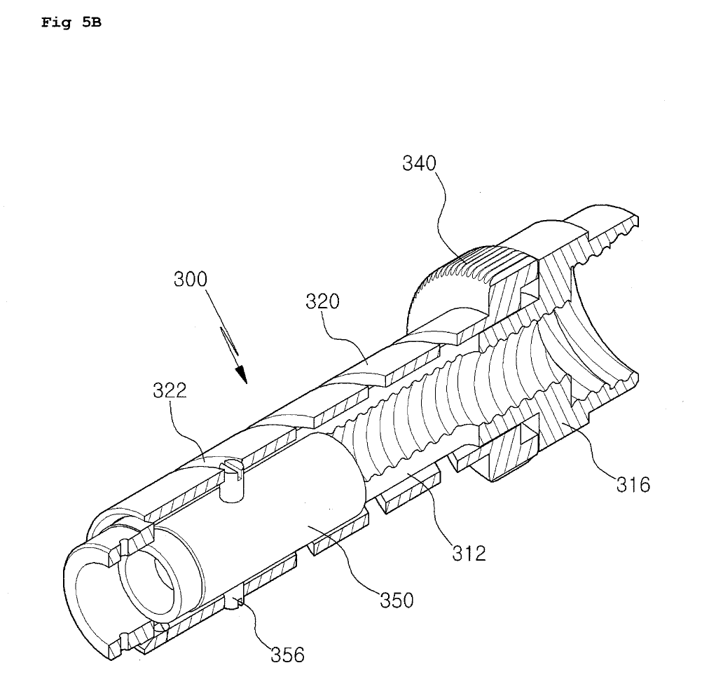

FIG. 1A is an assembled perspective view showing an electronic microscope according to a first exemplary embodiment of the invention, FIG. 1B is an exploded perspective view of FIG. 1A, FIG. 2 is a longitudinal cross-sectional view showing the internal structure of the electronic microscope according to the first exemplary embodiment of the invention, FIG. 3 is a perspective view showing an observation filter of a light guide of the electronic microscope according to the first exemplary embodiment of the invention, FIG. 4 is a perspective view showing a diffusion member of the electronic microscope according to the first exemplary embodiment of the invention, FIG. 5A is a longitudinal cross-sectional view showing a lens unit of the electronic microscope according to the first exemplary embodiment of the invention, and FIG. 5B is a perspective cross-sectional view showing a lens controller of the electronic microscope according to the first exemplary embodiment of the invention.

As shown in the figures, the electronic microscope according to a first exemplary embodiment of the invention generally includes a handle 220, a lens controller 300, and a light guide 400.

The handle 200 includes an outer body 210, a CMOS sensor board 230, a main board 240, and a display window 250. The size of the outer body 210 is suitable for being grasped in the hand of a user. The CMOS sensor board 230 is vertically provided inside the front portion of the outer body 210. A CMOS sensor (or CCD sensor) 220, which is an image sensor that converts an image magnified by the lens controller 300 and the light guide 400 into electrical signals, is mounted on the CMOS sensor board 230. The main board 240 is horizontally provided inside the outer body 210. The display window 250 is provided in the outer circumference of the outer body 210 such that an LED 244 can be exposed to the outside. In addition, the outer body 210 has an operation hole 262a into which a switch 260 is operably fitted.

On the main board 240, an image memory 241, tact switches 242, a USB port 243, and the LED 244 are mounted. The image memory 241 stores images, which are converted into electrical signals. The tact switches 242 turn on/off the electronic microscope or LEDs 410. The USB port 243 provides an electrical connection to a PC. The LED 244 serves to display the operating status of the electronic microscope to the outside.

In addition, a circuit of pathways is formed on the main board 240, providing an electrical connection to the above-described components via a USE cable or the like. Here, the switch 260 is in contact with the tact switch 242 on the main board 240, the display window 250 is provided above the LED 244, and the outer body 210 has a hole in one end, through which the USE cable passes.

The lens controller 300 includes an inner case 310, an outer case 320, a main case 330, a focus adjuster 340, and a lens unit 350. The inner case 310 is fixed to the front end of the outer body 210 of the handle 200. The outer case 320 is provided outside and is rotatably coupled with the inner case 310. The main case 330 covers the outer case 320 from outside. The focus adjuster 340 is provided on one end of the outer case 320 and protrudes from the main case 330 such that the outer case 320 can be rotated by the focus adjuster 340 from outside the main case 330. The lens unit 350 is inserted into the inner case 310 and moves back and forth in response to the rotation of the outer case 320, thereby magnifying a picked-up image at a proper ratio of magnification.

The inner case 310 has guide slots 312, an insert groove 314, a flange 316, and a second reflection-preventing section 318. The guide slots 312 are formed in both sides of the inner case 310 so as to guide the lens unit 350 in the longitudinal direction. The insert groove 314 is formed in the outer circumference of the inner case 310, and a power line (not shown), which supplies electric power to the LEDs 410, is received in the insert groove 314. The flange 316 is provided in the rear end of the inner case 310 such that it can be coupled with the front end of the outer body 210 of the handle 200. In addition, the second reflection-preventing section 318 is provided in the rear end of the inner case 310, and has a diffusely reflective portion that scatters light reflected from the CMOS sensor 220.

In addition, a third reflection-preventing section 418 is provided inside the inner case 310, and has a diffusely reflective portion that allows the lens unit 350 to move and scatters light reflected from the CMOS sensor 220.

The diffusely reflective portions of the second and third reflection-preventing sections 318 and 418 as well as a first reflection-preventing section 358, which will be described later, can be a scratched portion, a diffusely reflective coating, tapped or threaded portions, or the like. The diffusely reflective portion provides an irregular surface that prevents the light that is reflected from the CMOS sensor 220 from being reflected again. In addition, the flange 316 has a through-hole 270, through which the power line passes so as to supply electric power to the LEDs 410.

In particular, according to this embodiment, the inner circumferences of the second reflection-preventing section 318 and the third reflection-preventing section 418, as well as that of the first reflection-preventing section 358, which will be described later, are machined into the shape of threads, and all surfaces through which light can pass are shaded from light. This consequently prevents or minimizes diffuse reflection.

Preferably, the angle of the threads is set within the range from 55 to 65 degrees, and the threads are formed by cutting the surface to a depth of 0.5 mm, such that the lens unit 350 can smoothly slide without shaking.

The outer case 320 has spiral holes 322 in the circumference thereof, which communicate with the guide slots 312 in the inner case 310, and is rotatably coupled to the outer portion of the inner case 310. In addition, the focus adjuster 340 is provided on one end of the outer case 320 and protrudes from the main case 330 such that the outer case 320 can be rotated from outside using the focus adjuster 340. The outer surface of the focus adjuster 340 is formed as an anti-slip surface, which facilitates the rotation of the outer case 320.

The main case 330 is cylindrically shaped to surround the inner and outer cases 310 and 320. The main case 330 is rotatably coupled at one end with the focus controller 340 and is coupled at the other end with the light guide 400, which will be described later. The main case 330 is made of a transparent material so that inside can be seen from outside. The inner and outer cases 310 and 320 are preferably provided with a black coating so that light from the lens unit 350, which is inside the inner and outer cases 310 and 320, does not pass through the cases 310 and 320.

The light guide 400 includes the LEDs 410, an LED board 420, and an observation filter 440. The LEDs 410 are provided on the front end of the case 330 to generate light. The LEDs 410 are provided on the LED board 420, which has an opening 422 through which light emitted from the LEDs 410 can be uniformly radiated forward so that light having uniform brightness can be radiated on the object to be examined. The observation filter 440 is detachably provided on the front end of the main case 330 of the lens controller 300 to protect the LED board 420. The observation filter 440 facilitates observation of the body skin, the scalp, the nose, the mouth, ears, acupuncture spots in the ears, and the like.

The LEDs 410 are provided in a radial arrangement on the LED board 420, which is coupled to the front end of the main case 330 of the lens controller 300 and has the opening 422, through which light reflected from the object to be examined enters.

In addition, as shown in FIG. 4, the LED board 420 is optionally and preferably provided with a diffusion member (or diffusion plate) 430, which uniformly diffuses light through the opening 422. However, the present invention is not limited thereto. The diffusion member 430 is located in front of the LEDs 410 and has coupling rods 432 coupled with the outer circumference of the LED board 420. The coupling rods 432 are spaced apart from each other at preset intervals. The diffusion member 430 has an opening 434 in the central portion thereof, which is preferably aligned along the same center line as the opening 422 through which light, reflected from the object to be examined, enters.

The diffusion member 430 is made of a transparent or semitransparent light-transmitting material selected from among the group consisting of Polycarbonate (PC), Polymethylmethacrylate (PMMA), acryl, epoxy, Polyethylene Terephthalate (PET), and melamine resin. The diffusion member 430 can also be composed of one or more diffusion films or have a diffusing portion formed on its surface.

In addition, the observation filter 440 is provided in front of the LED board 420 so as to protect the LEDs 410, and its shape and size are determined to facilitate observation of the body skin, scalp, nose, mouth, ears, acupuncture spots in the ears, and the like.

The observation filter 440 has the shape of a cylinder, or more particularly, the shape of a cone, the diameter of which decreases toward the front end 441. In addition, the front end 441 of the observation filter 440 has a diameter D ranging from 2 to 7 mm, the side of the observation filter 440 has a curved surface, and the total height H of the observation filter 440 from the front end 441 to the rear end ranges from 15 to 30 mm.

Preferably, in the observation filter 440, the diameter D of the front end 441 can be 6 mm, and threads 442 can be formed in the rear end so as to mesh with threads on the main case 330. However, the present invention is not limited thereto.

In the observation filter 440, if the diameter of the front end 441 is in the range from 2 to 7 mm, it is possible to realize, in particular, overall observation of an acupuncture spot in the ear. It is also possible to provide a clear image of a specific region of the body.

For example, a variety of acupuncture spots are present in the ear, and each acupuncture spot corresponds to a particular region of the body. Accordingly, it is necessary to magnify one acupuncture spot and isolate it from the other spots in order to perform diagnosis on a corresponding body region based on the condition of the acupuncture spot, i.e., changes in the venation, wrinkles, or color thereof.

Therefore, it is necessary for the diameter D of the front end 441 of the observation filter 440 to be within the range from 2 to 7 mm in order to provide an isolated and complete view of a single acupuncture spot. If the diameter is less than 2 mm, the electric microscope shows merely a portion of one acupuncture spot without providing a complete view of the entire acupuncture spot. If the diameter is greater than 7 mm, the electric microscope shows two or more acupuncture spots at the same time. In this case, it is difficult or impossible to correctly diagnose which region of the body is in an abnormal state.

Accordingly, a variety of observation filters 440 ranging in size from 2 to 7 mm can be used according to the size of the ear. However, an observation filter 440 that has a diameter 6 mm and provides a wide view can be generally used.

In addition, the observation filter 440, which is suitable for observing acupuncture spots in the ear, has a height H in the range from 15 to 30 mm.

If the height of the observation filter 440 is less than 15 mm, it is difficult to observe a concave bottom. If the height of the observation filter 440 is greater than 30 mm, it is inconvenient for the operator to observe a convex region. The height of the observation filter 440 according to an exemplary embodiment of the invention is preferably 18 mm. In addition, the side surface of the observation filter 440 is optionally and preferably curved inward.

Meanwhile, as shown in FIG. 5A, the lens unit 350 includes one or more lenses 351, a cylindrical lens unit body 352, a plurality of spacers 354, two guide rods 356, and the first reflection-preventing section 358. The lens unit body 352 holds the lenses 351. The spacers 354 are formed in the inner circumference of the lens unit body 352 to space a plurality of lenses 351 apart from each other at preset intervals. The guide rods 356 protrude from the outer circumference of the lens unit body 352. The first reflection-preventing section 358 is provided in the rear end of the inner circumference of the lens unit body 352 and has a diffusely reflective portion that scatters light reflected from the CMOS sensor 220.

The diffusely reflective portion can be, for example, a scratched portion, a diffusely reflective coating, or tapped or threaded portions formed in the inner circumference of the first reflection-preventing section 358. The diffusely reflective portion of the first reflection-preventing section 358 provides an irregular surface that prevents light that is reflected from the CMOS sensor 220 from being reflected again. The diffusely reflective portion of the first reflection-preventing section 358 is formed by the same method and in the same shape as those of the second and third reflection-preventing sections 318 and 418.

As shown in FIG. 5B, the lens controller 300 is assembled by inserting the guide rods 356 of the lens unit 350 into the spiral holes 322 in the outer case 320 through the guide slots 312 in the inner case 310. As a result, when the outer case 320 is rotated by adjusting the focus adjustor 340, the outer case 320, having the spiral holes 322 therein, is rotated to press the guide rods 356 of the lens unit 350 back and forth. Since the directions in which the lens unit 350 can move are limited by the guide slots 312 in the inner case 310, the lens unit 350 is allowed to move only in the forward and backward directions.

Depending on the horizontal movement of the lens unit 350, the ratio of the distance between the object to be examined and the lens unit 350 to the distance between the lens unit 350 and the CMOS sensor 220 varies, thereby setting a suitable magnification. As such, the magnification and the focus of the electronic microscope are determined by the rotation of the outer case 320. Accordingly, in order to correctly set the focus at a specific magnification, it is preferable to increase the number of spiral holes 322 in the outer case 320 so that the outer case 320 can precisely rotate.

In addition, since the focus adjustor 340, which rotates the outer case 320, protrudes from the main case 330, it is possible to rotate the outer case 320 from outside the main case 330. In addition, the lens unit 350 can be moved back and forth by simply controlling the focus adjuster 340, without requiring the cumbersome operation of turning the entire main case 330. This, as a result, provides a structure that can be very conveniently operated and used.

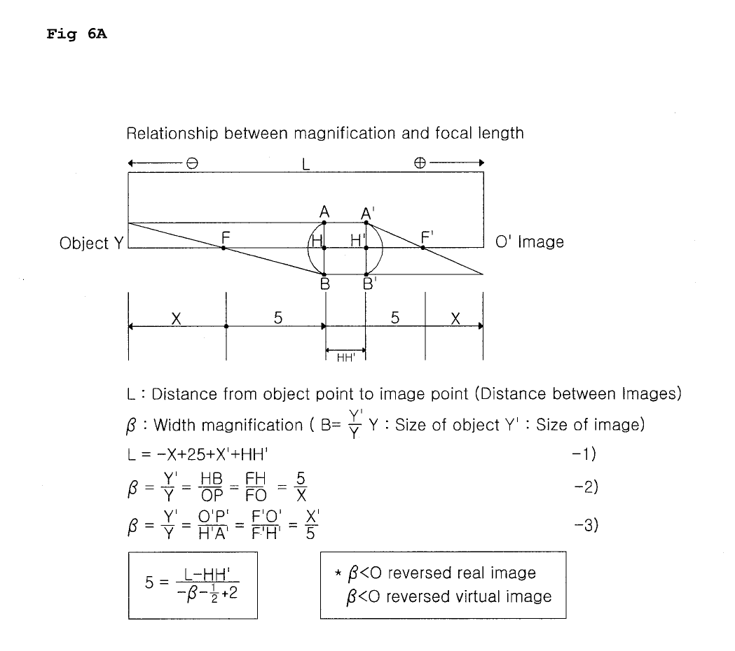

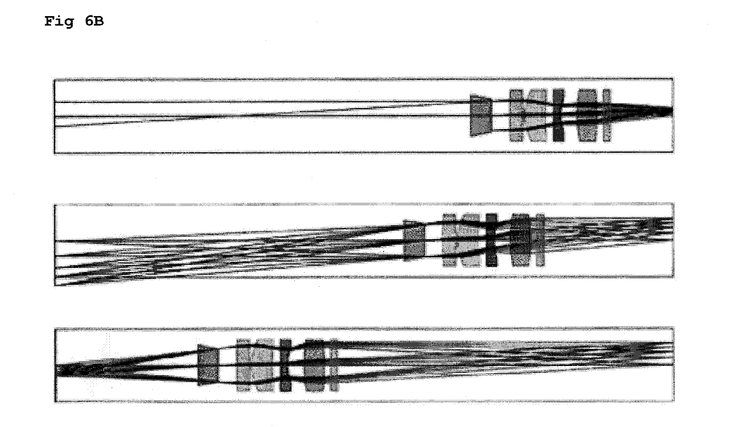

In addition, the relationship between the magnification and the focal length of the lens 351 can be calculated using the formula shown in FIG. 6A. Here, the focal length includes the length (i.e., height) of the acupuncture spot observation filter 440. The focal length of the electronic microscope according to this embodiment is constant regardless of the magnification (i.e., 35× to 150×). In this embodiment of the invention, the constitution of the lens unit 350 and the resolution of the CCD or CMOS sensor 220 are determined such that the length of the observation filter 440 ranges from 15 to 30 mm and the magnification ranges from 35× to 150×.

For example, as shown in FIG. 6B, the lens unit 350 includes five (5) lenses, which are made of different materials on the basis of the optical relationship between the magnification and the focal length, applied to “CODE-V software.” The same focal length is obtained for any magnification in the range from 35× to 150×.

As such, the performance of the lens unit 350 and the CMOS sensor 220 is optimized by the length of the observation filter 440. The focus remains correct even if the user adjusts the magnification of the lens unit 350 within the magnification range from 35× to 150× while maintaining the front end 441 of the observation filter 440 in contact with the ear skin. Accordingly, this greatly facilitates observation not only of acupuncture spots but also of specific body regions.

Next, the diameter of the front end 441 of the observation filter 440 for observing an acupuncture spot in the ear is displayed at the maximum possible size on a TV monitor or a PC monitor.

Specifically, an image picked up through the observation filter 440 is displayed in the shape of a circle on the monitor. The circular image occupies the greatest area on the rectangular screen of the monitor. This makes it possible to provide a separate image, which is greatest, on the screen of a given monitor using the observation filter 440. Accordingly, this greatly facilitates observation of the acupuncture spot in the ear and allows the image to be displayed with the greatest size on the screen.

After the electronic microscope according to the first embodiment of the invention is located so that the front end of the acupuncture spot observation filter 440 is adjacent to the skin of the ear, the user can observe an acupuncture spot in an intended position after applying electric power to the electronic microscope and the LEDs 410 by turning on the tact switch 142. Then, light emitted from the LEDs 410 can be uniformly diffused by the diffusion member 430 and can then radiate the ear, thereby providing illumination having uniform brightness to the object to be examined.

The light, uniformly radiated onto the object to be examined, is reflected from the object, thus allowing an image to be accurately sensed. The reflected light is sent to the lens unit 350. At this time, the user sets the magnification and the focal length by adjusting the focus adjuster 340 to rotate the outer case 320 a suitable amount.

When the image, the magnification and the focal length of which are set, approaches the CMOS sensor 220, which converts the image into electrical signals, a portion of the light (of the image) is reflected from the CMOS sensor 220. The light reflected from the CMOS sensor 220 does not enter the CMOS sensor 220 again because it is scattered by the first reflection-preventing section 358, which is provided behind the lens unit 350 and has the diffusely reflective portion, and the second reflection-preventing section 318, which is provided on the rear end of the inner case 310 and has the diffusely reflective portion.

When the lens unit 350 is moved forward, light reflected from the CMOS sensor 220 is scattered by the diffusely reflective portion of the third reflection-preventing section 418, which is provided inside the inner case 310, so that it does not enter the CMOS sensor 220 again.

Accordingly, only a portion of the image, which is correctly introduced into the CMOS sensor 220, is converted into electrical signals, which are in turn sent to a PC via a USE cable, so that the PC displays the picked-up image on a monitor by running a software program.

The screen displayed on the monitor has a circular shape due to the shape of the observation filter 440, a correct image is picked up using light, which is uniformly diffused through the diffusion member 430, and the light reflected from the CMOS sensor 220 does not enter again the CMOS sensor 220 since it is scattered by the first reflection-preventing section 358 and the second reflection-preventing section 318. Accordingly, the image displayed on the computer monitor provides a clear and clean image from which a minute structure of the object to be examined can be recognized.

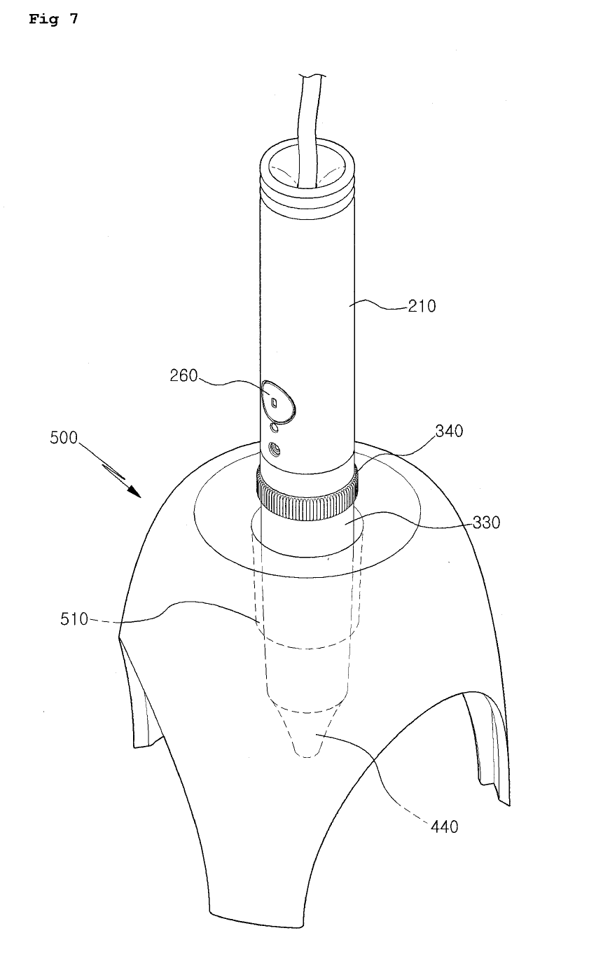

In addition, as shown in FIG. 7, the electronic microscope of this embodiment can be provided with a stand 500 in which the electronic microscope is held.

The stand 500 has a holder 510, which extends downward from the central portion thereof, such that the electronic microscope of this embodiment can be fitted into and held by the holder 510. The electronic microscope is fitted into the holder 510, with the light guide 400 facing downward and being spaced apart from the surface on which the stand 500 is placed. In this position, the user can use the electronic microscope in order to pick up an image of an object to be examined by adjusting the lens unit 350 as well as to magnify the image using the observing filter 440.

Below, a description will be given of en electronic microscope according to a second exemplary embodiment of the invention.

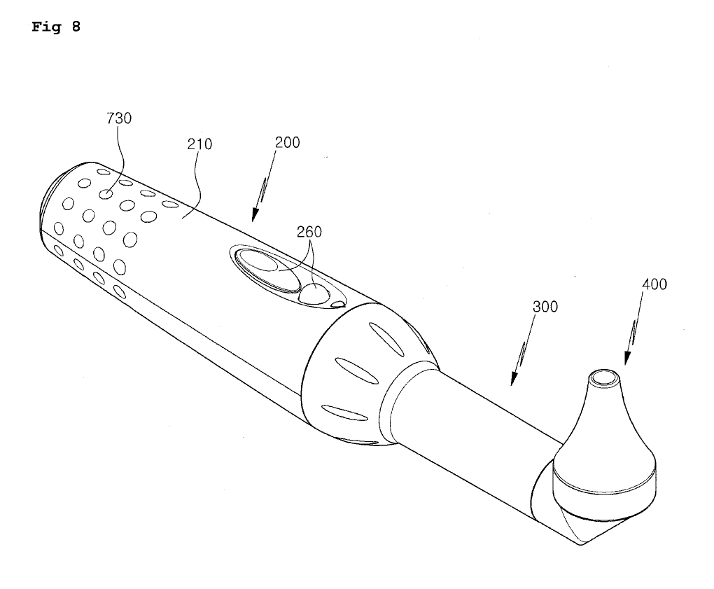

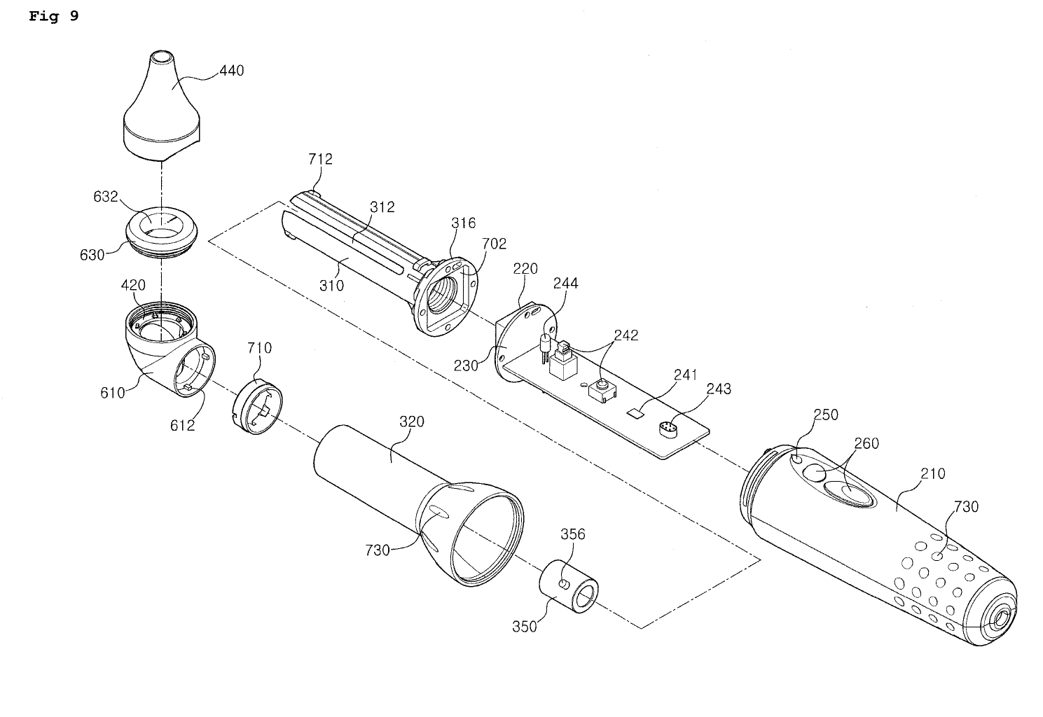

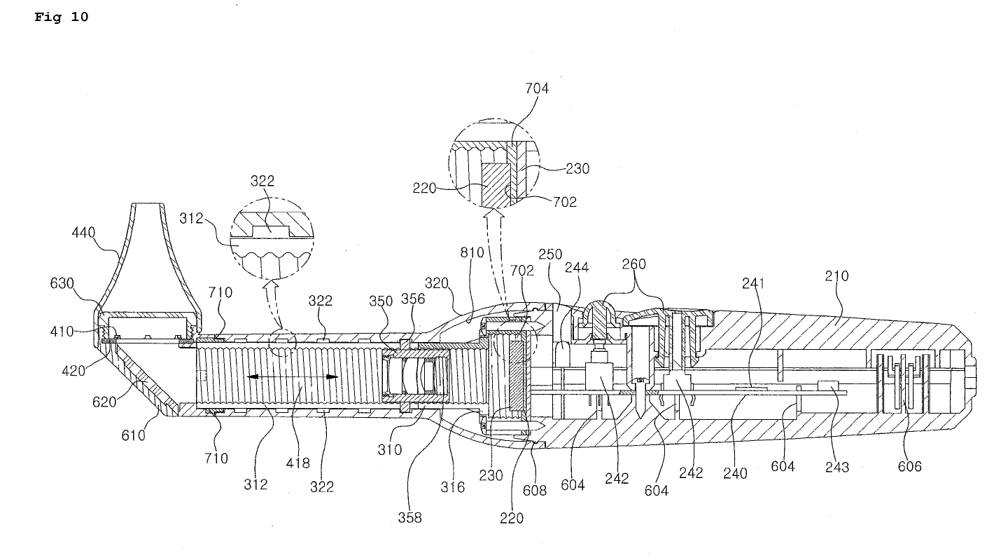

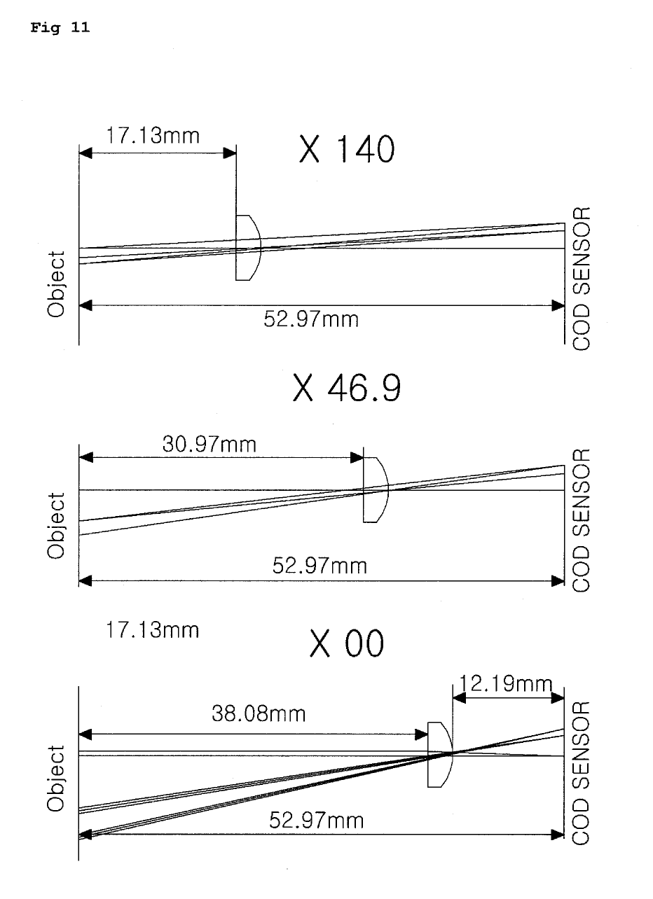

FIG. 8 is a perspective view showing the electronic microscope according to the second exemplary embodiment of the invention, FIG. 9 is an exploded perspective view showing the electronic microscope according to the second exemplary embodiment of the invention, FIG. 10 is a longitudinal cross-sectional view showing the electronic microscope according to the second exemplary embodiment of the invention, and FIG. 11 is diagrams showing the principle of image magnification of the electronic microscope according to the invention.

As shown in the figures, the electronic microscope according to the second exemplary embodiment of the invention generally includes a handle 220, a lens controller 300, and a light guide 400.

The handle 200 includes an outer body 210, a CMOS sensor board 230, a main board 240, and two switches 260. The size of the outer body 210 is suitable for being grasped in the hand of a user. The CMOS sensor board 230 is vertically provided inside the front portion of the outer body 210. A CMOS sensor (or CCD sensor) 220 is mounted on the CMOS sensor board 230. The main board 240 is horizontally provided inside the outer body 210. The switches 260 are operably provided on the outer circumference of the outer body 210.

The lens controller 300 includes an inner case 310, an outer case 320, and a lens unit 350. The inner case 310 is fixed to the front end of the outer body 210 of the handle 200. The outer case 320 is rotatably coupled with the front end of the outer body 210 while surrounding the inner case 310. The lens unit 350 is inserted inside the inner case 310 and moves back and forth in response to the rotation of the outer case 320, thereby magnifying a picked-up image at a proper ratio of magnification

The light guide 400 includes a light guide cap 610, a total reflection mirror 620, an LED board 420, a protective cap 630, and an observation filter 440. The light guide cap 610 is fixed to the front end of the inner case 310 and is bent at a right angle. The total reflection mirror 620 is provided inside the light guide cap 610, inclined at a specific angle. The LED board 420 is provided in the front end of the light guide cap 610. The protective cap 630 is detachably coupled with the front end of the light guide cap 610. The observation filter 440 is in the shape of a cone, and is used for observing a narrow hole such as the interior of the ears or nose.

The electronic microscope according to this embodiment having the above-described constitution can be used not only for magnification and short-distance photographing but also for video communication. Accordingly, a user can easily select a variety of ratios of magnification.

As shown in FIG. 11, the distance between the lens unit 350 and the CMOS sensor 220 can be adjusted in order to provide a variety of ratios of magnification, such as ×40, ×6.9, and ×00, based on the ratio of the distance between the object to be examined and the lens unit 350 to the distance between the lens unit 350 and the CMOS sensor (or CCD sensor) 220. This can be performed using two guide rods 356 protruding outward from the lens unit 350, two guide slots 312 formed in the inner case 310 along the longitudinal direction such that the guide rods 356 can extend across and slide along the guide slots 312, and spiral holes 322 recessed into the inner circumference of the outer case 320 such that the distal ends of the guide rods 356 can be inserted into the spiral holes 322.

When the outer case 320 surrounding the inner case 310 is rotated, the spiral holes 322 along the length of the outer case 322 rotates while pressing the guide rods 356, inserted into the spiral holes 322, back and forth. Since the directions in which the outer case 320 can move are limited by the guide slots 312 in the inner case 310, the lens unit is allowed to move only in the forward and backward directions.

Depending on the horizontal movement of the lens unit 350, the ratio of the distance between the object to be examined and the lens unit 350 to the distance between the lens unit 350 and the CMOS sensor 220 varies, thereby setting a suitable magnification.

The magnification and the focus of the electronic microscope of this embodiment are determined by the rotation of the outer case 320. In order to correctly set the focus at a specific magnification, it is necessary to precisely rotate the outer case 320 at specific positions.

Below, a detailed description will be given of the electronic microscope according to the second exemplary embodiment of the invention.

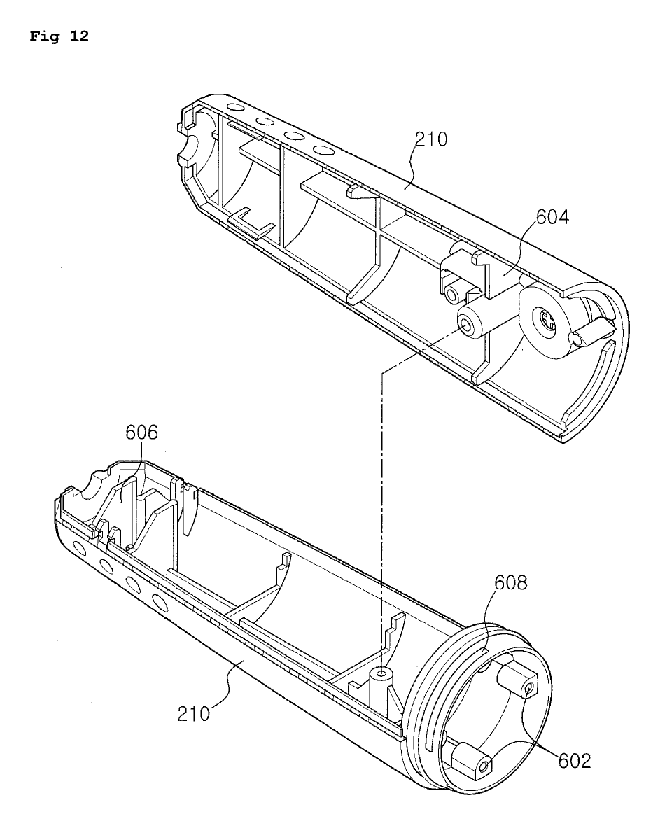

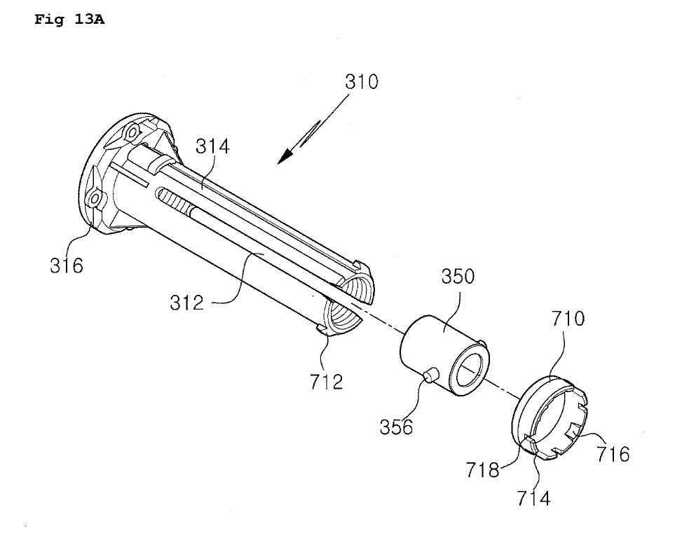

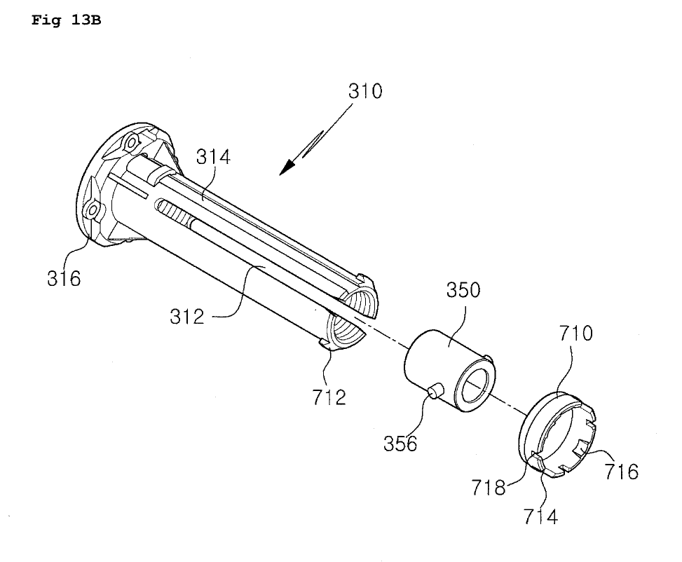

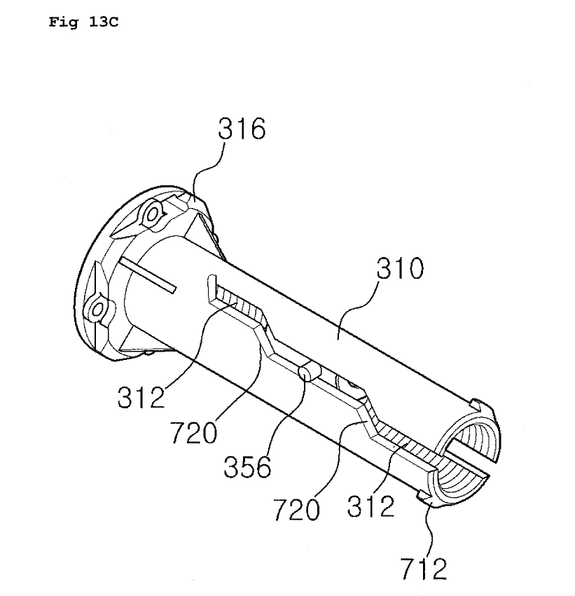

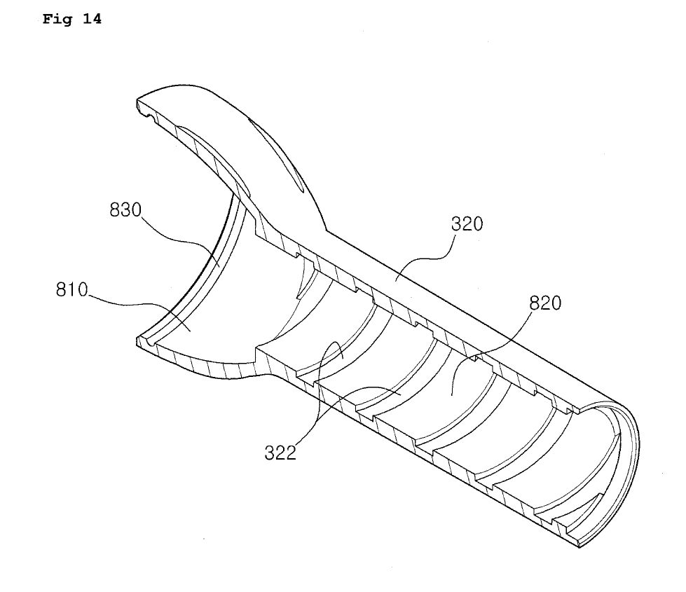

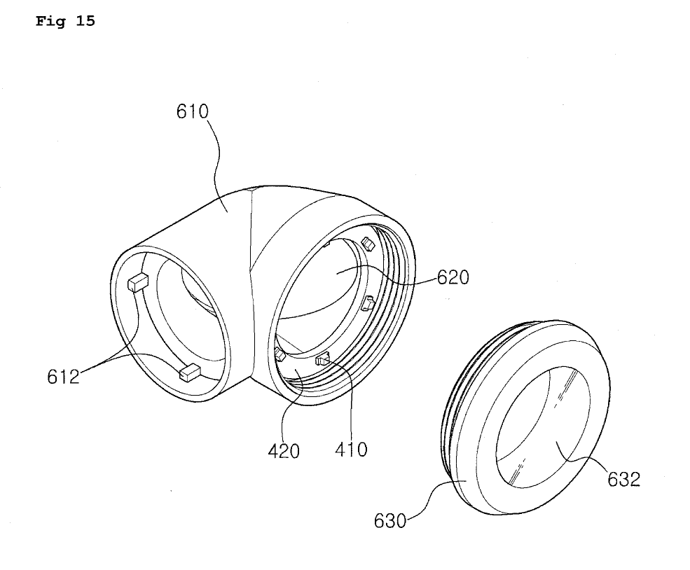

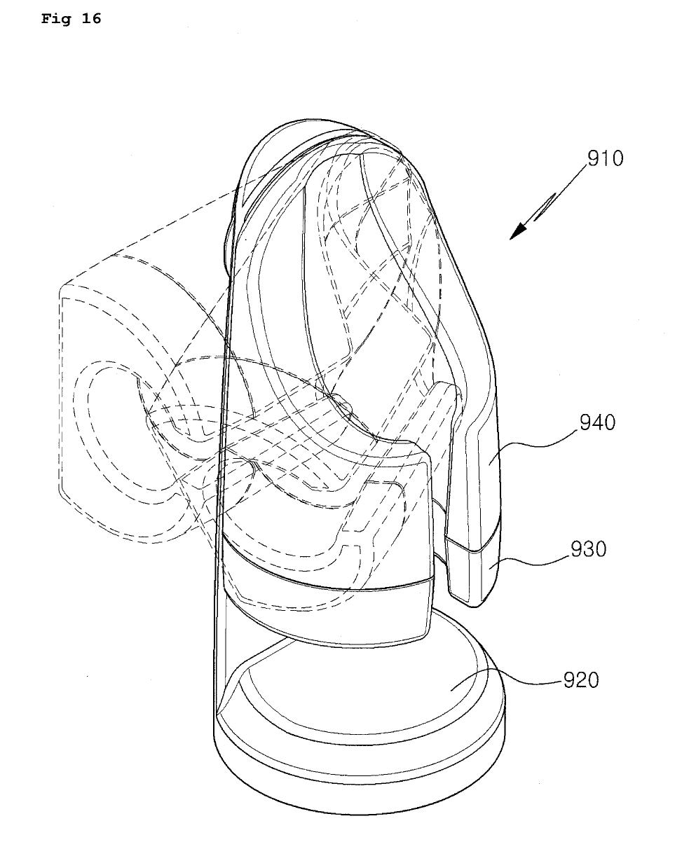

FIG. 12 is an exploded perspective view showing outer bodies of the electronic microscope according to the second exemplary embodiment of the invention, FIGS. 13A to 13C are perspective views showing an inner case of the electronic microscope according to the second exemplary embodiment of the invention, FIG. 14 is a partially cut-away perspective view showing an outer case of the electronic microscope according to the second exemplary embodiment of the invention, FIG. 15 is a perspective view showing a light guide cap of the electronic microscope according to the second exemplary embodiment of the invention, and FIG. 16 is a perspective view showing a stand, which holds the electronic microscope according to the second exemplary embodiment of the invention in an erected position.

As shown in FIG. 12, the outer body 210 of the handle 200 according to this embodiment includes, as integral parts, a plurality of ribs 602, a plurality support ribs 604, a plurality of fixing ribs 606, and a fitting portion 608. The ribs 602 have a fastening hole, which allows the flange 316 of the inner case 310 and the CMOS sensor board 230 to be fixed together. The support ribs 604 are formed inside the outer body 210, allowing the main board 240 to be horizontally provided. The fixing ribs 606 are provided behind the support ribs 604 so as to hold a USB cable. The fitting portion 608 extends along the outer circumference of the front portion of the outer body 210 such that the outer body 210 can be rotatably coupled with the outer case 320. This configuration can, of course, be applied to the outer body 210 according to the first exemplary embodiment of the invention.

As shown in FIGS. 13 to 13C, the inner case 310 of this embodiment has two guide slots 312, an insert groove 314, and a flange 316, which are integral parts thereof. The guide slots 312 are formed to guide the lens unit 350 so that the lens unit 350 can move back and forth. The power line groove 314 is recessed to a specific depth such that a power line 280, which supplies electric power to chip-type LEDs 410, is received in the power line groove 314. The flange 316 is coupled with the rib 602 of the outer body 210, and a seating recess 702 is recessed to a specific depth into the flange 316 such that the CMOS sensor 220 can be placed therein. With the flange 316, the inner case 310 has a generally T-shaped configuration.

In addition, a closing member 710, which closes the guide slots 312 while coupling with the light guide cap 610, is provided on the front end of the inner case 310.

The closing member 710 is ring-shaped, and has fitting recesses 714, insert protrusions 716, and a plurality of fixing recesses 718, which are integral parts thereof. The fitting recesses 714 are coupled with fitting protrusions 712, which are formed on the front end of the inner case 310. The insert protrusions 716 are inserted into the front end of the guide slots 312 to close the guide slots 312. The fixing recesses 718 are for fixing the light guide cap 610.

The light guide cap 610 has fixing protrusions 612, which are inserted into the fixing recesses 718 formed in the closing member 710. This configuration can improve the fixing force between the closing member 710 and the light guide cap 610.

In the inner case 310, as shown in FIG. 13C, a plurality of inclined guide slot portions 720 can be formed in the two guide slots 312, which guide the lens unit 350.

When the inclined guide slot portions 720 are formed in specific positions of the inner case 310, which requires precise adjustment, the lens unit 350 moves along the inclined path along the inclined guide slot portions 720. Accordingly, assuming that the outer case 320 is rotated at the same angle, the horizontal displacement of the lens unit 350 is reduced, and thus the inner case 310 can be precisely adjusted.

FIG. 14 is a view showing the outer case 320 of this embodiment. The outer case 320 includes a funnel portion 810 and a linear pipe portion 820. The funnel portion 810 is coupled with the fitting portion 608 in the front portion of the outer body 210. The funnel portion 810 is in the form of an orifice, the diameter of which gradually increases such that the funnel portion 810 can be rotatably coupled with the fitting portion 608. The linear pipe portion 820 is located close to the inner case 310.

The spiral grooves 322 are formed in the circumference of the linear pipe portion 820, recessed to a specific depth into linear pipe portion 820 such that the front ends of the guide rods 356 in the lens unit 350 can be fitted into the spiral grooves 322. The funnel portion 810 has an annular fitting groove 830 in the inner surface of the front end thereof, which is rotatably coupled with the fitting portion 608 in the outer circumference of the front end of the outer body 210. Accordingly, after coupled with the front end of the outer body 210, the outer case 320 is still rotatable.

FIG. 15 is a perspective view of the light guide cap 610 that is coupled with the front end of the inner case 310. Inside the cylindrical body of the light guide cap 610, which is bent at a right angle, the elliptical mirror 620 is inclined at an angle of about 45 degrees. The ring-shaped LED board 420, on which the chip-type LEDs 410 are mounted, is provided on a stepped portion on the front end of the light guide cap 610. The protective cap 630, equipped with a transparent window 632, is provided outside the LED board 420. The protective cap 630 fixes the LED board 420 while preventing impurities from entering the interior of the protective cap 610.

Accordingly, light emitted from the LEDs 410 is used in photographing an object to be examined at a short distance or a dark region such as an ear hole.

In this case, it is possible to raise the resolution of the object to be examined by arranging the LEDs 410 so as to be populated in one side rather than being uniformly distributed over the LED board 420. Accordingly, light emitted from the LEDs 410 is reflected from the object to be examined, thereby picking up an image. The picked-up image is in turn totally reflected from the total reflection mirror 620 and is then sent to the lens unit 350.

At this time, the user can adjust the ratio of magnification and the focus by properly rotating the outer case 320. Then, the CMOS sensor 220 converts the image into electrical signals, which are in turn sent to, for example, a PC through the USB cable connected to the USE port of the main board 240. Afterwards, the PC displays the picked-up image on a computer monitor by running a software program. The picked-up image (i.e., a still image or a dynamic image) can be stored in the computer or be sent to the outside via the Internet.

Although the inner case 310, the outer case 320, and the light guide 400 of this embodiment are applicable to the first exemplary embodiment, this is not intended to limit the present invention.

Specifically, in this embodiment, the closing member 710 is provided in the inner case 310, and the fitting protrusions 712 of the inner case 310 and the fixing protrusions 612 of the light guide cap 610 are formed for coupling with the closing member 710. These components can also be provided in the inner case 310 and the light guide 400 of the first exemplary embodiment such that they can be coupled with the closing member 710.

In addition, as in this embodiment, the guide slots 312 formed in the inner case 310 of the first exemplary embodiment can also have the inclined guide slot portions 720. The observation filter 440 of the first embodiment can also be vertically oriented.

In addition, it is preferable that a plurality of anti-slip members 730 are formed on the outer circumference of one end of the outer case 320 and on the outer circumference of the outer body 210, respectively. Although the anti-slip members 730 are illustrated as protrusions formed on the outer circumference, the present invention is not limited thereto.

Alternatively, thin pads, the surface of which is roughened by knurling or the like, can be attached to the outer case 320 and the outer body 210, respectively.

The electronic microscope of this embodiment can pick up an image of a body region such as the skin or scalp by magnifying it or pick up an image of a region such as the interior of the nose or ears, which is difficult to observe with the naked eye, at a short-distance, and then display the image on a PC monitor.

FIG. 16 is a perspective view showing an example of a microscope stand 910 that can hold the electronic microscope of this embodiment in the erected position.

The microscope stand 910 can be rotated or fixed in order to hold the electronic microscope at a variety of angles.

The microscope stand 910 includes a fixing mount 920, in which the electronic microscope is held, and a rotatable mount 930, which rotates the electronic microscope by a specific angle. The rotatable mount 930 is rotatably coupled to the fixing mount 920. Accordingly, it is possible to rotate the electronic microscope by a variety of angles by inserting the handle 200 of the electronic microscope into a holder 940 of the rotatable mount 930 as well as to fix the electronic microscope in the rotated position.

For example, it is possible to maintain the electronic microscope in the erected position during video communication, or to horizontally fix it while a precise component is being assembled or repaired or a test sample is being observed.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An electronic microscope comprising:
a handle having an outer body enclosing a main body and an image sensor, wherein an image memory, a tact switch, and a universal serial bus port are mounted on the main board;
a lens controller fixed to a front end of the outer body of the handle, wherein the lens controller includes an inner case having a guide slot in the circumference and a flange on one end to which the handle is coupled, an outer case rotatably coupled with the inner case from outside, wherein the outer case has a spiral passage in the circumference communicating with the guide slot, a lens unit inserted into the inner case, wherein the lens unit has a guide rod inserted into the guide slot and into the spiral passage such that the lens unit moves back and forth in response to rotation of the outer case; and
a light guide coupled to a front end of the lens controller, wherein the light guide includes a light emitting diode board, light emitting diodes radially mounted on the light emitting diode board, and an observation filter detachably provided on the front end of the lens controller, wherein the observation filter has a conical shape with the diameter decreasing toward a front end thereof, and observes body regions including the skin, scalp, nose, mouth, ears, and acupuncture spots in the ears.

2. The electronic microscope according to claim 1, wherein the light guide further includes a diffusion member coupled with the light emitting diode board by a coupling rod, wherein the diffusion member provides light having uniform brightness to an object to be examined by uniformly diffusing light emitted from the light emitting diodes.

3. The electronic microscope according to claim 1, wherein the lens controller further includes a main case covering the outer circumference of the outer case and a focus adjustor provided on one end of the outer case, wherein the focus adjustor rotates the outer case from outside, thereby allowing to precisely adjust the lens unit.

4. The electronic microscope according to claim 1, wherein the lens unit includes a lens body fixing one or more lenses, a plurality of spacers provided in the inner circumference of the lens body to maintain the lenses apart from each other, the guide rods protruding both sides of the outer circumference of the lens body, and a first reflection-preventing section provided on the inner circumference of a rear end of the lens body, wherein the first reflection-preventing section has a diffusely reflective portion that scatters light reflected from the image sensor in order to provide a clear and clean image.

5. The electronic microscope according to claim 1, wherein the flange of the inner case has a second reflection-preventing section in which a diffusely reflective portion is formed, wherein the diffusely reflective portion scatters light reflected from the image sensor that converts light reflected from an object to be examined into electrical signals.

6. The electronic microscope according to claim 1, wherein the inner case has a third reflection-preventing section therein, which allows the lens unit to move and has a diffusely reflective portion scattering light reflected from the image sensor.

7. The electronic microscope according to claim 4, wherein the diffusely reflective portion has a roughened portion selected from the group consisting of a scratched portion, a diffusely reflective coating, tapped portions, and threaded portions, wherein the surface of the roughened portion is roughened to scatter the light reflected from the image sensor.

8. The electronic microscope according to claim 5, wherein the diffusely reflective portion has a roughened portion selected from the group consisting of a scratched portion, a diffusely reflective coating, tapped portions, and threaded portions, wherein the surface of the roughened portion is roughened to scatter the light reflected from the image sensor.

9. The electronic microscope according to claim 6, wherein the diffusely reflective portion has a roughened portion selected from the group consisting of a scratched portion, a diffusely reflective coating, tapped portions, and threaded portions, wherein the surface of the roughened portion is roughened to scatter the light reflected from the image sensor.

10. The electronic microscope according to claim 4, wherein the diffusely reflective portion has threaded portions, which are oriented at an angle of 60 degrees and cut to a depth of 0.5 mm.

11. The electronic microscope according to claim 5, wherein the diffusely reflective portion has threaded portions, which are oriented at an angle of 60 degrees and cut to a depth of 0.5 mm.

12. The electronic microscope according to claim 6, wherein the diffusely reflective portion has threaded portions, which are oriented at an angle of 60 degrees and cut to a depth of 0.5 mm.

13. The electronic microscope according to claim 1, wherein the front end of the observation filter has a diameter from 2 to 7 mm and a height from 15 to 30 mm.

14. The electronic microscope according to claim 1, further comprising a stand for holding the electronic microscope, wherein the stand has a holder extending downward such that the electronic microscope is inserted into the holder with the light guide facing down.

15. The electronic microscope according to claim 1, wherein the outer body of the handle has:
a plurality of ribs to which the flange on one end of the inner case and an image sensor board are fixed;
a plurality of support ribs on which main board is provided;
a plurality of fixing ribs holding a universe serial bus cable; and
a fitting portion extending along an outer circumferential portion thereof so as to be rotatably coupled with the outer case.

16. The electronic microscope according to claim 1, wherein the light guide includes:
a light guide cap fixed to the front end of the inner case and bent at a right angle;
a total reflection mirror fixed to the front end of the inner case and inclined at an angle of 45 degrees;
the light emitting diode board provided in a front end of the light guide cap and having an annular shape, wherein a plurality of the light emitting diodes mounted on the light emitting diode board are chip-type;
a protective cap detachably coupled with the front end of the light guide cap to prevent impurities from entering; and
the observation filter provided on a front end of the protective camp and having a conical shape.

17. The electronic microscope according to claim 1, wherein the flange provided on one end of the inner case is coupled with the outer body of the handle and has a seating recess in which the image sensor is placed therein.

18. The electronic microscope according to claim 1, further comprising a closing member coupled with a front end of the inner case to close the guide slot of the inner case and coupled with the light guide, wherein the closing member has a fitting recess in the inner circumference coupled with the inner case, an insert protrusion inserted into a front end of the guide slot in the circumference of the inner case, and a fixing recess to which the light guide is fixed.

19. The electronic microscope according to claim 16, further comprising a closing member coupled with a front end of the inner case to close the guide slot of the inner case and coupled with the light guide, wherein the closing member has a fitting recess in the inner circumference coupled with the inner case, an insert protrusion inserted into a front end of the guide slot in the circumference of the inner case, and a fixing recess to which the light guide is fixed.

20. The electronic microscope according to claim 18, wherein the inner case has a fitting protrusion in the front end thereof coupled with the fitting recess of the closing member, and wherein the light guide has a fixing protrusion fixedly inserted into the fixing recess of the inner case.

21. The electronic microscope according to claim 19, wherein the inner case has a fitting protrusion in the front end thereof coupled with the fitting recess of the closing member, and wherein the light guide has a fixing protrusion fixedly inserted into the fixing recess of the inner case.

22. The electronic microscope according to claim 1, wherein the guide slot in the circumference of the inner case has a plurality of inclined guide slot portions, which guide the lens unit in order to precisely control the lens group that moves back and forth along the guide slot.

23. The electronic microscope according to claim 17, wherein the guide slot in the circumference of the inner case has a plurality of inclined guide slot portions, which guide the lens unit in order to precisely control the lens group that moves back and forth along the guide slot.

24. The electronic microscope according to claim 1, further comprising a microscope stand, which includes a fixing mount holding the electronic microscope spaced apart from a surface where the microscope stand is placed, a rotatable mount rotatably coupled with the fixing mount, and a holder coupled with the rotatable mount, wherein the electronic microscope is held in the holder.

25. The electronic microscope according to claim 1, wherein the outer body of the handle and the outer case of the lens controller have a plurality of anti-slip protrusions formed on the outer circumference, wherein the anti-slip protrusions prevent slipping when a user holds the handle.
